(19) United States
(12) Patent Application Publication
(10) Pub. No.: US 2022/0024266 A1
(43) Pub. Date: Jan. 27, 2022

(54) TIRE DEFLECTION SENSING SYSTEM

(71) Applicant: Bridgestone Americas Tire Operations, LLC, Nashville, TN (US)

(72) Inventors: Terence E. Wei, Copley, OH (US); Hans R. Dorfi, Akron, OH (US); Amit K. Agarwal, Brentwood, TN (US); Thomas W. Rodgers, Des Moines, IA (US); Kevin E. Scheifele, Atwater, OH (US)

(21) Appl. No.: 17/297,072

(22) PCT Filed: Dec. 12, 2019
(86) PCT No.: PCT/US2019/065835

§ 371 Date: May 26, 2021

Related U.S. Application Data
(60) Provisional application No. 62/783,292, filed on Dec. 21, 2018.

(51) Int. Cl. B60C 23/06; B60C 23/20; B60C 23/04

(52) U.S. Cl. CPC B60C 23/066; B60C 2019/004; B60C 23/0488; B60C 23/20

(57) ABSTRACT

A tire and wheel assembly includes a wheel having a portal and a tire mounted on the wheel, thereby forming a cavity. The assembly further includes a deflection sensor mounted on the wheel over the portal, at a location outside the cavity such that no portion of the deflection sensor is inside the cavity.

### FIELD OF INVENTION

The present disclosure relates to a tire sensing system. More particularly, the present disclosure relates to a system for measuring deflection in a tire as it rolls over a surface.

### BACKGROUND

As a tire rolls over a surface, any given portion of the crown region of the tire will experience deflection as it rolls into and out of contact with the surface. If a tire is inflated to a relatively low pressure, the tire experiences greater deflection and has a greater footprint (i.e., a surface contact area). If a tire is inflated to a relatively high pressure, the tire experiences less deflection and has a smaller footprint. It is known to place sensors inside of a tire cavity to measure pressure and temperature, or to measure tire deflection.

### SUMMARY OF THE INVENTION

In one embodiment, a tire and wheel assembly includes a wheel having a through hole and a tire mounted on the wheel, thereby forming a cavity. The assembly further includes a valve extending through the wheel, from a location outside the cavity to a location inside the cavity. The valve is spaced away from the through hole. The assembly also includes a deflection sensor mounted on the wheel over the through hole, at a location outside the cavity such that no portion of the deflection sensor is inside the cavity.

In another embodiment, a method of regulating pressure in a tire includes providing a tire mounted on a wheel of a vehicle. The tire and wheel define a cavity. The wheel has a through hole disposed therein. The method further includes providing a deflection sensor on the wheel over the through hole, at a location outside the cavity such that no portion of the deflection sensor is inside the cavity. The method also includes monitoring, with the deflection sensor, a selected area of an inner wall of the tire opposite the through hole. The method further includes calculating a tire deflection based on the monitoring of the selected area of the inner wall of the tire opposite the through hole. The method also includes determining a desired tire deflection of the tire based at least in part on non-tire data and adjusting air pressure inside the tire until the calculated tire deflection is within a predetermined amount of the desired tire deflection.

In yet another embodiment, a tire and wheel assembly includes a wheel having a portal and a tire mounted on the wheel, thereby forming a cavity. The assembly further includes a deflection sensor mounted on the wheel over the portal, at a location outside the cavity such that no portion of the deflection sensor is inside the cavity.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a schematic drawing of a partial cross-section of one embodiment of a tire and wheel assembly;

FIGS. 2A-2C are exemplary indicia for an inner surface of a tire;

FIG. 3 is an exemplary graph illustrating deflection of a tire;

FIG. 4 is a block diagram illustrating an exemplary system for regulating tire pressure; and

FIG. 5 is a schematic drawing of a partial cross-section of an alternative embodiment of a tire and wheel assembly.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

“Axial” or “axially” refer to a direction that is parallel to the axis of rotation of a tire.

“Bead” refers to the part of the tire that contacts the wheel and defines a boundary of the sidewall.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Radial” and “radially” refer to a direction perpendicular to the axis of rotation of a tire.

“Sidewall” refers to that portion of the tire between the tread and the bead.

“Tread” refers to that portion of the tire that comes into contact with the road under normal inflation and load.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

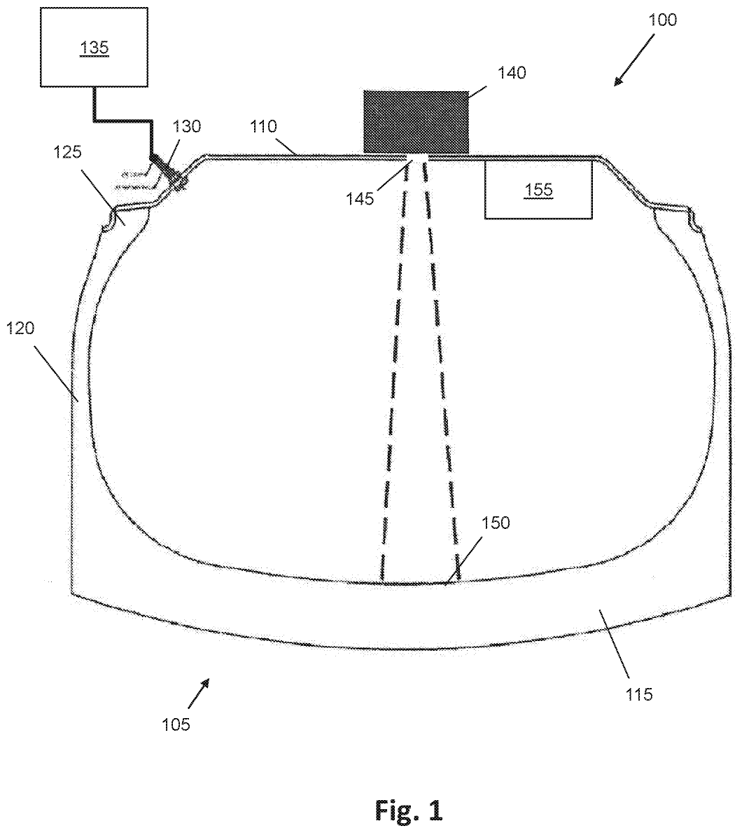

FIG. 1 is a schematic drawing of a partial cross-section of one embodiment of a tire and wheel assembly 100. Only a lower half of the assembly 100 is shown in this view. The assembly 100 includes a tire 105 mounted on a wheel 110. The tire 105 includes a tread 115 in a crown region, as well as a pair of sidewalls 120. The sidewalls 120 terminate in bead regions 125 that are mounted to the wheel 110. When the tire 105 is mounted on the wheel 110, the assembly forms an internal cavity.

A valve 130 extends through the wheel 110, from a location outside the cavity to a location inside the cavity. The valve 130 allows compressed air to be injected into the cavity from an external source. The valve also allows air from inside the cavity to be released into the atmosphere. In the illustrated embodiment, the valve 130 is connected to an air regulator 135. The air regulator 135 may be connected to the valve 130 as needed to inflate or deflate the tire 105. Alternatively, the air regulator 135 may remain connected to the valve 130 during operation of the vehicle, thereby allowing the tire 105 to be inflated or deflated during use of the vehicle. In an alternative embodiment, an air regulator is not employed and the tire may instead be manually inflated by an external air source.

A sensor 140 is mounted on the wheel 110 at a location outside the cavity such that no portion of the sensor 140 is inside the cavity. While the sensor 140 is shown as mounted at the center of the wheel 110, it should be understood that the sensor may be offset from the center of the wheel. Mounting a sensor 140 at a location outside the cavity allows the sensor to be removed or serviced while the tire 105 remains mounted on the wheel 110. Additionally, by mounting the sensor 140 outside of the cavity, the vehicle may provide power to the sensor through a wired connection or through wireless transmission.

The sensor 140 is mounted over a portal 145 that is spaced away from the valve 130. In one embodiment, the portal 145 is a through hole, or a pin hole. In such an embodiment, the sensor 140 is exposed to the air inside of the cavity. In an alternative embodiment, the portal 145 is a window made of glass or a polymeric material. In such an embodiment, the sensor 140 is not exposed to the air inside of the cavity.

The sensor 140 includes at least a deflection sensor that monitors an area 150 of an inner wall of the tire 105. In the illustrated embodiment, the area 150 being monitored is an underside of the tread 115 and is opposite the portal 145. In an alternative embodiment, the area that is monitored is at a location on the underside of the tread that is not directly opposite the portal. In another alternative embodiment, the area that is monitored is an interior surface of the sidewall of the tire, or a shoulder region of the tire.

The deflection sensor may employ any sensing means. For example, the deflection sensor may be an optical sensor (or a laser sensor) that senses light reflected off the area 150 of the inner wall of the tire 105. An optical sensor may include a light source, such as a laser, an LED, an incandescent light, or other light source.

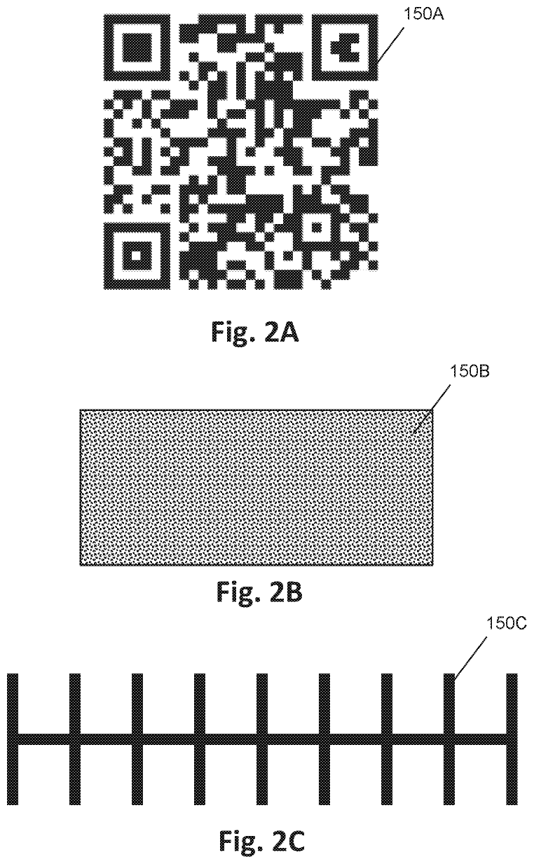

The area 150 of the inner wall of the tire may be marked with indicia to aid in the optical detection of tire deflections. FIGS. 2A-2C illustrate examples of such indicia. In FIG. 2A, the area 150A is marked with a 3D barcode. In FIG. 2B, the area 150B is marked with speckles. In FIG. 2C, the area 150C is marked by a plurality of lines or hash-marks. In each embodiment, the indicia provides an additional visual indicator of changes to the tire surface. These examples are not intended to be limiting, and it should be understood that other types of indicia may be employed. In an alternative embodiment (not shown), protrusions or recesses in the inner surface of the tire may also aid in the optical detection of tire deflections. For example, cords or ridges that protrude from the inner surface of the tire, or dimples or other recesses in the inner surface of the tire may aid in optical detection. In other alternative embodiments, the inner surface of the tire may be smooth and include no markings.

The deflection sensor is not limited to an optical sensor or a laser sensor. In alternative embodiments, the deflection sensor may be, without limitation, an ultrasonic sensor, radar, millimeter wave radar, structured light sensors, a radio frequency sensor, or a magnetic sensor.

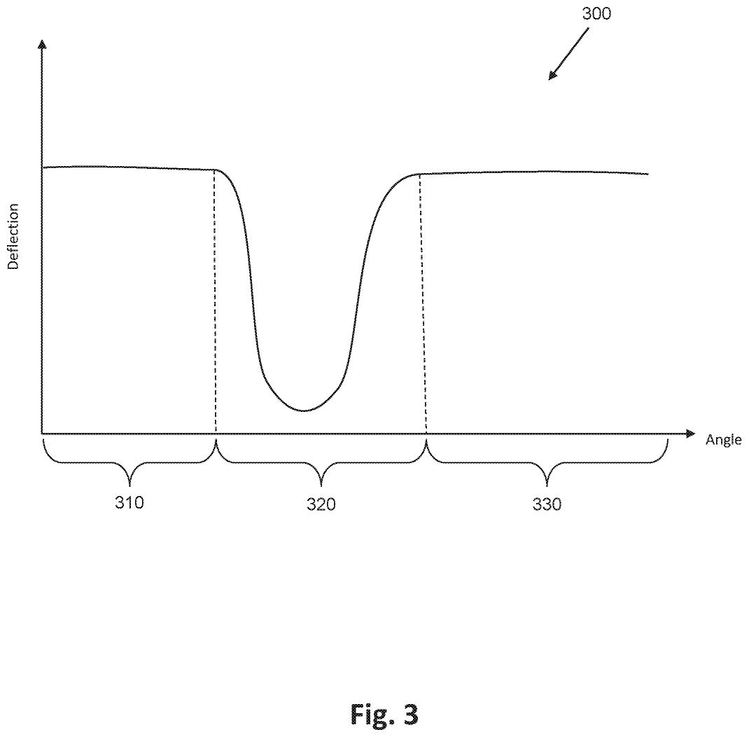

By monitoring the area 150 of the inner wall of the tire 105, the deflection sensor detects deflections or deformations in that portion of the tire as it rolls into and out of contact with a surface. FIG. 3 is an exemplary graph 300 illustrating the deflection of an area 150 of a tire 105 as a function of the angle as the tire 105 rolls along a surface. As shown in this graph, the monitored area 150 of the tire is spaced from the surface as the tire rotates through a first angle 310, and thus experiences no deflection. As the tire 105 continues to rotate through a second angle 320, the monitored area 150 of the tire rolls into contact with the surface and becomes part of the footprint of the tire 105. Thus, the monitored area 150 of the tire deflects by some amount. If the tire 105 is inflated to a lower level, the tire will deflect more and have a larger footprint than when the tire is inflated to a higher level. The deflections are depicted here as a negative deflection. This depiction is arbitrary, however, and the deflection may be depicted as positive or negative. After the monitored area 150 of the tire rolls out of contact with the surface, the tire 105 continues to rotate through a third angle 330. Once again, the monitored portion experiences no deflection as it rotates through the third angle 330.

On some vehicles, it may be desirable for tires to have different footprints for different applications. For example, in an agricultural vehicle, it may be desirable for a tire to have a large footprint and greater deflection when the vehicle is traveling over a field to avoid damaging crops or damaging the tires. It may be further desirable for a tire on an agricultural vehicle to have a small footprint and less deflection when the vehicle is traveling over a road at a higher speed. Likewise, in other vehicles such as off road vehicles, trucks, and passenger cars, it may be desirable to adjust the footprint of a tire as the vehicle travels on different surfaces or at different speeds.

Returning to FIG. 1, the sensor 140 may further include a position sensor or an accelerometer to provide data for determining the position of the sensor 140 and the monitored area 150. The position sensor may be an encoder. The accelerometer may provide acceleration data that a computer processor can analyze to determine an angular position of the sensor 140. The sensor 140 may also include both an accelerometer and a position sensor. In an alternative embodiment, an accelerometer or position sensor is disposed on the wheel 110 or tire 105 separately from the sensor 140. In an alternative embodiment, an orientation sensor may be employed instead of a position sensor. In one such embodiment, the orientation sensor would detect when the sensor is pointed down at the ground (and therefore the center of the footprint) to trigger the deflection sensor to make a measurement.

The sensor 140 may also include a temperature and pressure sensor. While the deflections of a tire are correlated to the internal temperature and pressure of a tire, other factors may affect the amount of deflection that occurs. Thus, the data obtained from a temperature and pressure sensor can be used to confirm the monitored deflections and also identify other issues with the tire. In embodiments in which the portal 145 is a through hole, a temperature and pressure sensor in the sensor 140 may be able to obtain meaningful data while mounted entirely outside of the cavity. If the portal 145 is a window, or if it is otherwise desirable to monitor the temperature and pressure from a sensor located inside the cavity, a second sensor 155 may be employed. In the illustrated embodiment, the second sensor 155 is mounted to the wheel 110. In an alternative embodiment (not shown), the second sensor is mounted to an inner surface of the tire. In another alternative embodiment, the second sensor may be omitted. In another alternative embodiment, the sensor includes a separate temperature sensor. In yet another alternative embodiment, the sensor includes a separate pressure sensor.

The sensor 140 may also include a humidity sensor. The humidity inside of the cavity may affect the pressure, and thus may affect the amount of deflection that occurs. The data obtained from a humidity sensor can therefore be used to confirm the monitored deflections and also identify other issues with the tire. In embodiments in which the portal 145 is a through hole, a humidity sensor in the sensor 140 may be able to obtain meaningful data while mounted entirely outside of the cavity. If the portal 145 is a window, or if it is otherwise desirable to monitor the humidity from a sensor located inside the cavity, the humidity sensor may be employed in the second sensor 155. In an alternative embodiment (not shown), the humidity sensor may be a third sensor mounted internally in the cavity. In another alternative embodiment, the humidity sensor may be omitted.

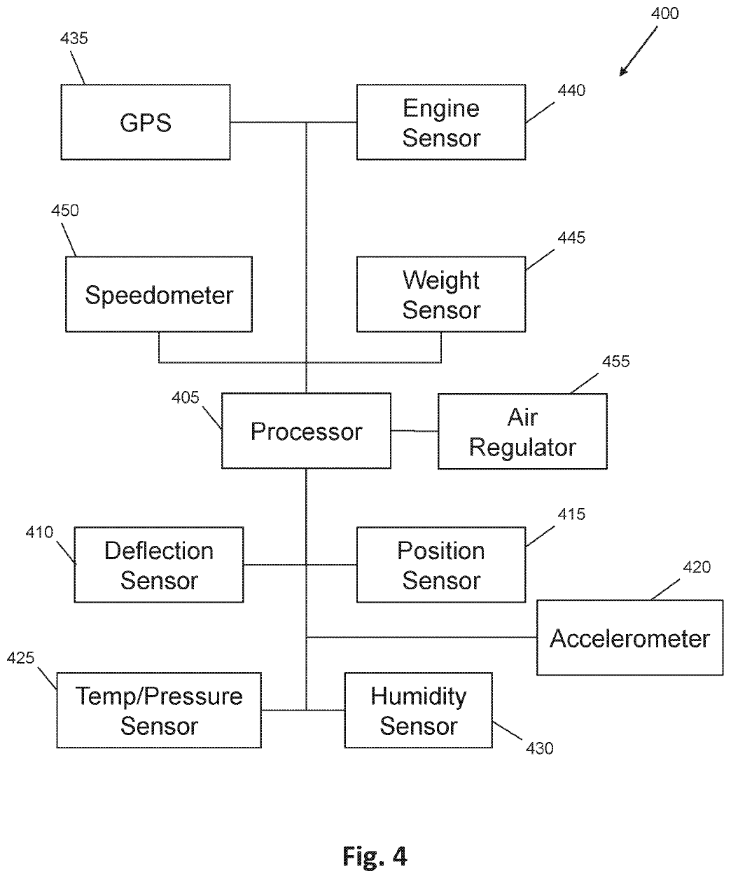

The sensors described above may be integrated into a system for monitoring a tire. Additionally, the sensors described above may be employed in a system for regulating air pressure in a tire. FIG. 4 is a block diagram illustrating an exemplary system 400 for regulating tire pressure. It should be understood that the blocks represent system components that may be housed together in a common housing or in multiple separate housings. It should be further understood that additional components may be employed, including multiples of the same component for redundancy purposes. For example, while a single processor 405 is illustrated, any of the illustrated components may include an associated processor.

Each of the other components is shown as being in signal communication with the processor 405. The communication may be through wires or other physical media, or it may be through wireless communication means, such as through radio frequency (RF) transmissions. The communications may also be a combination of wired and wireless communication. Additionally, certain components may be in signal communication with each other in a manner not illustrated here.

The processor 405 is in communication with a deflection sensor 410, such as one of the deflection sensors described above. The deflection sensor 410 transmits data related to the deflection of the monitored area of the tire to the processor 405. Additionally, a position sensor 415 transmits data related to the position of the deflection sensor 410 to the processor 405. An accelerometer 420 may also transmit data related to the acceleration of the deflection sensor 410. Based on the data from the deflection sensor 410, the position sensor 415, and the accelerometer 420, the processor calculates the deflection of the tire as rolls over a surface. In an alternative embodiment, the processor 405 may calculate the deflection of the tire with fewer inputs than are shown. In another alternative embodiment, an orientation sensor may be employed instead of a position sensor.

The processor 405 also is in signal communication with a temperature and pressure sensor 425. The temperature and pressure sensor 425 transmits data related to the temperature and pressure inside of the cavity of the tire. While the sensor 425 is identified as a single sensor that detects both temperature and pressure, it should be understood that a first sensor may be detect temperature while a second sensor detects pressure. The first and second sensor may be disposed in the same housing or in different housings.

The processor 405 is also in signal communication with a humidity sensor 430. The humidity sensor 430 transmits data related to the humidity inside of the cavity of the tire. The processor may incorporate the temperature, pressure, or humidity data when determining the deflection of the tire.

The data transmitted by the deflection sensor 410, the position sensor 415, the accelerometer 420, the temperature and pressure sensor 425, and the humidity sensor 430 may be referred to collectively as sensors that collect tire-related data, or tire data, because the data are related to and extracted from a tire. Additional tire sensors may be employed to monitor and transmit other tire-related data, such as tire identification, strain, wear, and other properties.

With continued reference to FIG. 4, the processor 405 is also in signal communication with sensors that collect non-tire-related data, or non-tire data. For example, the processor 405 is in signal communication with a Global Positioning System (GPS) 435. The GPS 435 calculates a geographic position based on satellite transmissions. The GPS 435 or the processor 405 may determine the terrain that a vehicle is traveling over by correlating GPS data with terrain data stored in a database or other memory (not shown). For example, the GPS 435 or the processor 405 may determine that the vehicle is traveling across a field or traveling on a highway.

The processor 405 is also in signal communication with an engine sensor 440 that monitors an engine, such as by monitoring engine strain. Engine strain data may be used by the processor 405 to calculate a load on the vehicle.

Additionally, the processor 405 is in signal communication with a weight sensor 445. The weight sensor may directly sense weight in a vehicle, a portion of the vehicle, or in a trailer connected to the vehicle.

The processor 405 is also in signal communication with a speedometer 450 that measures the speed of the vehicle. The processor may also be in signal communication with other sensors, such as a vehicle accelerometer or a suspension sensor. Such sensors may provide data to the processor that indicates whether the vehicle is traveling over smooth or bumpy terrain. Additionally, the processor may receive input from a user, such as an indication of terrain or environmental conditions.

Based at least in part on the non-tire data, the processor 405 determines a desired tire deflection. For example, the processor 405 may determine a desired tire deflection based on one or more of the vehicle speed, vehicle acceleration, terrain data, vehicle load, and engine strain. The determination may be based on an algorithm, machine learning, or by referring to lookup tables. The lookup tables may be populated manually based on test results, or through machine learning. For example, based on the non-tire data, the processor 405 may determine that the vehicle is carrying heavy equipment on a dirt road at medium speed. In such conditions, a medium level of deflection may be desired. As another example, the processor 405 may determine that the vehicle is not carrying a load and is traveling across a field at low speed. In such conditions, a high level of deflection may be desired. As yet another example, the processor 405 may determine that the vehicle is not carrying a load, and is travelling over a road at high speeds. In such conditions, a low level of deflection may be desired.

Based on additional data, such as the temperature, pressure, or humidity inside the tire cavity, the processor calculates a pressure that corresponds to the desired tire deflection. In the illustrated embodiment, the processor 405 is in signal communication with an air regulator 455. The processor 405 transmits signals to the air regulator 455 to inflate or deflate the tire, and thus adjust the air pressure inside the tire until the observed tire deflection is within a predetermined amount of the desired tire deflection. In other words, the pressure adjustment may be based in part on at least one of the measured temperature, the measured pressure, or the measured humidity.

In an alternative embodiment (not shown) the processor displays inflation status and recommendations to a user. Thus, when an air regulator is not employed, the user may manually inflate or deflate the tire to achieve the desired tire deflection. In all embodiments, the data may be displayed to a user or stored. The data may be employed in an iterative process to refine the desired tire deflection for certain conditions.

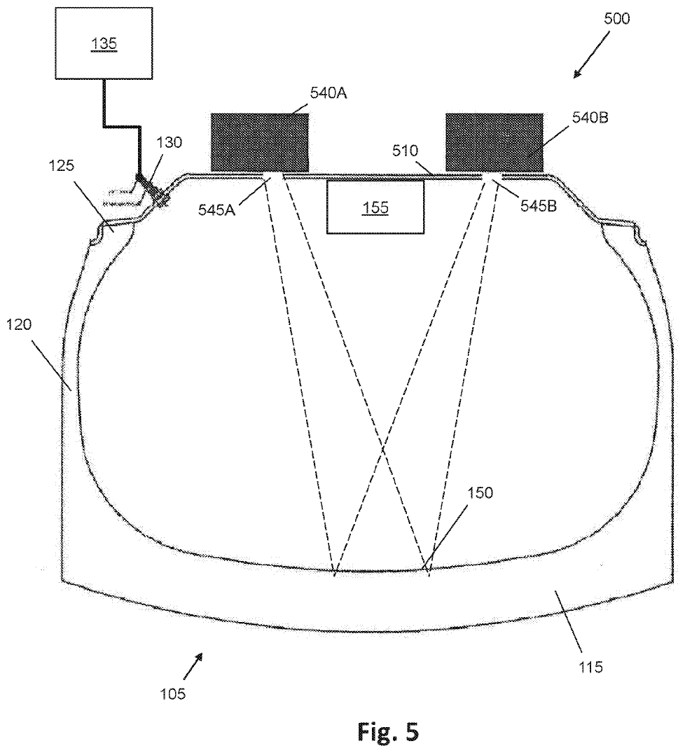

FIG. 5 is a schematic drawing of a partial cross-section of an alternative embodiment of a tire and wheel assembly 500. The assembly 500 is substantially the same as the assembly 100 described above with respect to FIG. 1, except for the differences discussed herein. Like reference numerals are used for like elements.

In the illustrated embodiment, the tire 105 is mounted on a modified wheel 510. Instead of a single external sensor, a first external sensor 540A is mounted on the wheel 510 over a first portal 545A and a second external sensor 540B is mounted on the wheel 510 over a second portal 545B. Each of the first and second sensors 540A,B may be the same as the external sensor 140 described above. In one embodiment, the first sensor 540A is the same type of sensor as the second sensor 540B. In an alternative embodiment, the first sensor 540A is a different type of sensor than the second sensor 540B. For example, one of the external sensors may be an optical sensor while the other sensor is a radio frequency sensor.

In the illustrated embodiment, the first and second external sensor 540A,B monitor the same area 150 of the tire 105, with each sensor 540A,B monitoring the area 150 at a different angle. By monitoring the same area 150 at different angles, the deflection of the area may be measured more accurately. In an alternative embodiment (not shown), each of the external sensors monitors a different area of the tire.

In each of the embodiments described above, the components described may be dedicated for use with a single tire. However, some of the components may be used for multiple tires. For example, a single processor may be in signal communication with sensors from multiple tires. Additionally, a single air compressor can connected to multiple tires.

While it may be desirable to employ sensors on every tire of a vehicle, it may be acceptable to only monitor a single tire on each axle, and regulate the pressure of all of the tires on that axle based on the monitoring of the single tire. In some instances, it may be acceptable to only monitor a single tire on the vehicle, and regulate the pressure of all of the tires on the vehicle based on the monitoring of the single tire.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A tire and wheel assembly comprising:
a wheel having a through hole;
a tire mounted on the wheel, thereby forming a cavity;
a valve extending through the wheel, from a location outside the cavity to a location inside the cavity, wherein the valve is spaced away from the through hole; and
a deflection sensor mounted on the wheel over the through hole, at a location outside the cavity such that no portion of the deflection sensor is inside the cavity.

2. The tire and wheel assembly of claim 1, further comprising a temperature and pressure sensor.

3. The tire and wheel assembly of claim 1, further comprising an accelerometer.

4. The tire and wheel assembly of claim 1, wherein the deflection sensor includes one of a position sensor and an orientation sensor.

5. The tire and wheel assembly of claim 1, wherein the tire includes indicia on an inner surface of the tire at a location opposite the deflection sensor.

6. The tire and wheel assembly of claim 1, further comprising a processor in signal communication with the deflection sensor.

7. The tire and wheel assembly of claim 6, further comprising an air regulator connected to the valve and in signal communication with the processor.

8. The tire and wheel assembly of claim 1, wherein the deflection sensor is a sensor selected from the group consisting of: an optical sensor, an ultrasonic sensor, a radio frequency sensor, a magnetic sensor, a radar, a millimeter wave radar, a structured light sensor and a laser sensor.

9. A method of regulating pressure in a tire, the method comprising:
providing a tire mounted on a wheel of a vehicle,
wherein the tire and wheel define a cavity, and
wherein the wheel has a through hole disposed therein;
providing a deflection sensor on the wheel over the through hole, at a location outside the cavity such that no portion of the deflection sensor is inside the cavity;
monitoring, with the deflection sensor, a selected area of an inner wall of the tire opposite the through hole;
calculating a tire deflection based on the monitoring of the selected area of the inner wall of the tire opposite the through hole;
determining a desired tire deflection of the tire based at least in part on non-tire data; and
adjusting air pressure inside the tire until the calculated tire deflection is within a predetermined amount of the desired tire deflection.

10. The method of claim 9, wherein the non-tire data is selected from the group consisting of: vehicle speed, vehicle acceleration, terrain data, vehicle load, and engine strain.

11. The method of claim 9, further comprising monitoring one of a position and an orientation of the deflection sensor.

12. The method of claim 9, further comprising monitoring a humidity level inside the tire.

13. The method of claim 12, wherein the step of adjusting the air pressure inside the tire is based in part on the humidity level inside the tire.

14. The method of claim 9, further comprising monitoring a temperature inside the tire.

15. The method of claim 14, wherein the step of adjusting the air pressure inside the tire is based in part on the temperature inside the tire.

16. A tire and wheel assembly comprising:
a wheel having a portal;
a tire mounted on the wheel, thereby forming a cavity; and
a deflection sensor mounted on the wheel over the portal, at a location outside the cavity such that no portion of the deflection sensor is inside the cavity.

17. The tire and wheel assembly of claim 16, wherein the portal is a window.

18. The tire and wheel assembly of claim 17, further comprising a temperature and pressure monitoring sensor disposed inside of the cavity.

19. The tire and wheel assembly of claim 16, further comprising a valve extending through the wheel, from a location outside the cavity to a location inside the cavity, wherein the valve is spaced away from the portal.

20. The tire and wheel assembly of claim 16, further comprising a second deflection sensor mounted on the wheel over a second portal.
